(19) United States
(12) Patent Application Publication
(10) Pub. No.: US 2005/0249231 A1
(43) Pub. Date: Nov. 10, 2005

(54) Methods and systems for reliable distribution of media over a network

(76) Inventor: Asif Khan, Mumbai (IN)

Correspondence Address: Brian P. Hopkins, Esq.;Mintz, Levin, Cohn, Ferris, Glovsky and Popeo, P.C, The Chrysler Center, 666 Third Avenue, 24th Floor, New York, NY, 10017, US

(21) Appl. No.: 10/998,068

(22) Filed: Nov. 24, 2004

Related U.S. Application Data
(60) Provisional application No. 60/525,127, filed on Nov. 25, 2003.

(51) Int. Cl. H04L 12/26

(52) U.S. Cl. 370/428; 714/748

(57) ABSTRACT

Embodiments of the invention are directed to methods and systems for providing efficient, scalable and reliable transport of large media files to multiple receivers over digital video broadcast (DVB) standards-based broadcast networks. Transport Reliability is achieved using Forward Error Correction (FEC) and a selective, Negative Acknowledgement (NACK) mechanism over an IP-based unicast feedback path. Out-of-band command and control messages over DVB network are used for initiation and coordination between sender and receivers.

### CLAIM TO PRIORITY

This application claims priority under 35 U.S.C. §119(e) to U.S. provisional patent application No. 60/525,127, filed Nov. 25, 2003, the entire disclosure of which is herein incorporated by reference.

### FIELD OF THE INVENTION

Embodiments of the present invention are directed to digital media, and more specifically to systems and methods for enabling the broadcast for reliable and efficient distribution of digital multimedia content to multiple receivers.

### BACKGROUND OF THE INVENTION

Broadcast networks, such as satellite and cable networks, offer a natural way to multicast data over large geographical areas. This contrasts with the difficulties in providing large-scale IP multicast networks, such as traversing several (potentially congested) router hops incurring packet delays. A number of European satellite service providers have been offering pilot multicast services mostly based on Digital Video Broadcasting (DVB).

Experiences suggest this may be an attractive service, for say, a digital cinema system for delivering digitized motion pictures, compressed and encrypted, to theaters. Specifically, to combine the merits of the broadcast nature of satellites with the growing availability of standardized DVB receiver components would be desirable. There are, however, drawbacks to using multicast over geosynchronous (GEO) satellite links. For example, to ensure low receiver cost, many broadcast satellite systems provide delivery from a central hub transmitter (often shared with a digital television uplink), which do not support duplex multicast communication. Thus, reliability and error correction are a problem.

Moreover, the diverse range of multicast applications and the variety of multicast network topologies makes it next to impossible to achieve a universal one-size-fits-all multicast transport protocol. Accordingly, the present invention incorporates multicast protocol design techniques for a satellite (or other broadband connection) based operation to provide a reliable multicast service for the transfer of large media files in an efficient and scalable manner.

### SUMMARY OF THE INVENTION

Embodiments of the present invention provide one or more methods and systems for providing efficient, scalable and reliable transport of large media files to multiple receivers over digital video broadcast (DVB) standards-based broadcast networks. Specifically, for reliable transport of large media files over DVB standards based broadcast networks, some of the embodiments of the invention include one or more of: a Negative Acknowledgement (NACK) oriented repair processes with timer-based feedback suppression; use of out-of-band command and control messages for initiation and/or coordination (for example) between sender and receivers; round-trip timing collection; and group-size determination/estimation.

In one embodiment of the invention, a method for error correction for digital video broadcast includes receiving a digital video broadcast from a sender. The digital video broadcast may include a multiplexed packetized transmission stream (TS) comprising at least one packetized elementary stream (PES) for predetermined content and comprising at least one of related meta-data information, integrity check information, frame information, related frame meta-data, frame integrity check information and one or more messages. The method may also include initiating a repair process for sending a negative acknowledgement (NACK) to the sender for retransmitting a lost or corrupt packet.

In another embodiment of the invention, an apparatus for error correction for digital video broadcast includes receiving means for receiving a digital video broadcast from a sender. The digital video broadcast may include a multiplexed packetized transmission stream (TS) comprising at least one packetized elementary stream (PES) for predetermined content and comprising at least one of related meta-data information, integrity check information, frame information, related frame meta-data, frame integrity check information and one or more messages. The apparatus may also include initiating means for initiating a repair process for sending a negative acknowledgement (NACK) to the sender for retransmitting a lost or corrupt packet.

In yet another embodiment of the invention, a receiver for a digital DVB system is provided and may include a playback module for receiving a transport stream and for initiating a repair process for sending a negative acknowledgement (NACK) to a sender for retransmitting a lost or corrupt packet of the transport stream. The playback module may include a return management module for initiating a negative acknowledgement (NACK) message and determining a content of the message, a transport stream receiver module, and a reliable multicast over IP module.

In still yet another embodiment of the invention, a method for negative acknowledgement (NACK) suppression on a digital video broadcast (DVB) network is provided and may include transmitting a digital video broadcast to a plurality of receivers. The digital video broadcast may include a multiplexed packetized transmission stream (TS) comprising at least one packetized elementary stream (PES) for predetermined content and comprising at least one of related meta-data information, integrity check information, frame information, related frame meta-data, frame integrity check information and one or more messages. The method may also include estimating a sender-group greatest-round-trip-timing (GRTT) for a group of receivers in the DVB network, estimating a size of the group, randomly selecting a respective back-off timeout period for the group according to a truncated exponential distribution, and determining a mean of the distribution as a function of the sender-group estimate and the size estimate of the group.

In another embodiment of the invention, an apparatus for negative acknowledgement (NACK) suppression on a digital video broadcast (DVB) network includes transmitting means for transmitting a digital video broadcast to a plurality of receivers. The digital video broadcast may include a multiplexed packetized transmission stream (TS) comprising at least one packetized elementary stream (PES) for predetermined content and comprising at least one of related meta-data information, integrity check information, frame information, related frame meta-data, frame integrity check information and one or more messages. The apparatus may also include estimating means for estimating a sender-group greatest-round-trip-timing (GRTT) for a group of receivers in the DVB network, and/or for estimating a size of the group, random selection means for randomly selecting a respective back-off timeout period for the group according to a truncated exponential distribution, and determining means for determining a mean of the distribution as a function of the sender-group estimate and the size estimate of the group.

In yet a further embodiment of the present invention, a transmission device for a digital DVB system may include a creation module for capturing and encoding digital content, a processing and management module for processing the captured content and a delivery module for creating a transport stream of data packets for the content to a plurality of receivers. The delivery module may include a transmission management module including a transport stream generation module, a return channel management module and a reliable multicast module. The return channel management module includes a negative acknowledgement (NACK) processing module, a receiver group greatest-round-trip estimation module and a group size estimation module.

Other embodiments include computer readable media and computer application programs for enabling a computer system for performing any one or more of the method embodiments disclosed in the present application

Still other embodiments, objects and advantages, will be readily apparent to those of skill in the art in view of the disclosure of the present application.

### BRIEF DESCRIPTION OF THE FIGURES

FIG. 1 is a schematic flow diagram of a digital cinema system according to some embodiments of the present invention.

FIG. 2 is a block diagram illustrating sender components for reliable broadcast according to some embodiments of the invention.

FIG. 3 is a block diagram illustrating receiver components for reliable broadcast according to some embodiments of the invention.

FIG. 4 is a block diagram illustrating overall components for reliable broadcast according to some embodiments of the invention.

### DETAILED DESCRIPTION

Unless otherwise defined, all technical and scientific terms used herein have the same meaning as commonly understood by one of ordinary skill in the art to which this invention belongs. Although methods, systems and materials similar or equivalent to those described herein can be used in the practice or testing of the invention, suitable methods, systems and materials are described below. In the case of conflict, the present specification, including definitions, will control. In addition, the materials, methods, and examples are illustrative only and not intended to be limiting.

Embodiments of the present invention facilitate error detection at a receiving end of a digital video broadcasting system, by means of NACK encoding scheme, which allows multiple receivers to request for selective re-transmission of corrupted or lost data through a return path. Specifically, some embodiments of the present invention provide a unicast connectivity path to provide feedback from a receiver to a sender, thus shifting responsibility for error correction to the receiver.

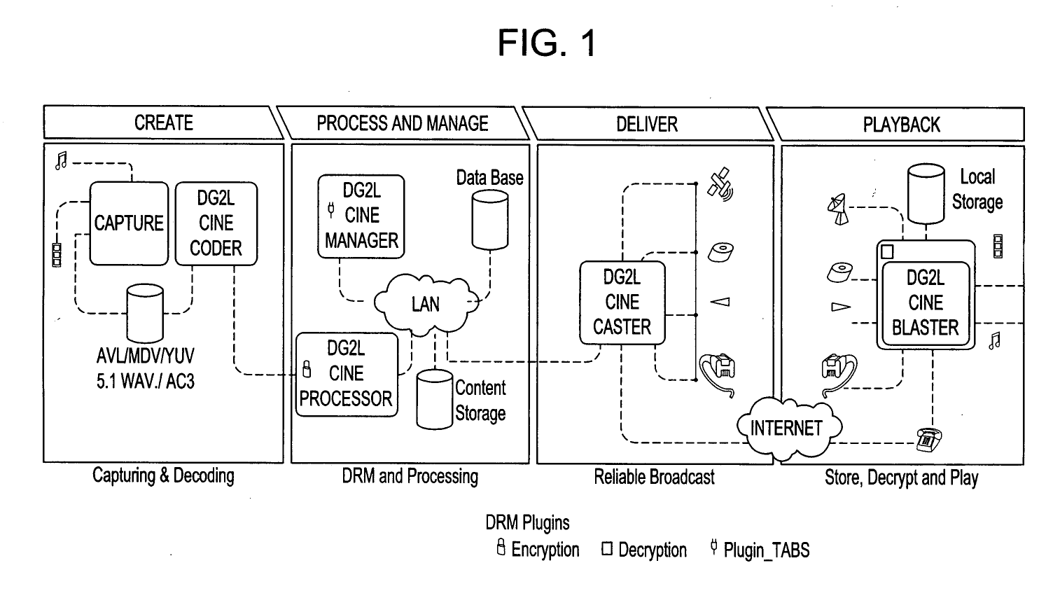

FIG. 1 illustrates a block diagram of a general overview of a digital cinema system according to some of the embodiments of the invention. As shown, the system may be divided into four general components: a Creation block for capturing and encoding content, a Process and Manage (PM) block for digital rights management and processing of the content, a Delivery block for reliable broadcasting of the content and a Playback block, for receiving, storing, decrypting and/or presentation of the content through a projector, television and/or the like.

Digitized video is captured in the Creation block preferably in uncompressed, high-definition (HD) resolution supporting any one of a number of digital formats (e.g., avi, mov, etc.). For example, uncompressed video, for certain content (e.g., a movie, television show, and the like) is processed and converted, via a cine-coder to MPEG-4 ASP@1080p 720p format (for example), by the cine-coder (or other current or future compression format). The audio file is preferably encoded via the cine-coder in MPEG-4 AAC LC (e.g., HQ@Level3) or AC3 format (or other current or future compression format). The audio and video for the program may be stored.

The PM block may be a networked system including a cine-manager and a cine-processor, with database storage and program storage. The cine-processor accepts compressed video/audio data and generates one or more packetized elementary streams (PESs)(in, for example, MPEG-4 format), for transmission over an MPEG-2 (for example) transport stream to a broadcast session.

The cine-manager may be used to help facilitate error detection at a receiver end of a broadcast of the data, ensure confidentiality, integrity and authentication of the streams. Moreover, the cine-manager may also configure screenings, configure the list of locations (e.g., theaters) which will be showing the movie, configure monthly, weekly and daily theater plans, and schedule and configure broadcast sessions. Accordingly, the movie content may be stored (content storage), and the screening configurations and scheduling data may be stored in a database.

The Delivery block may be used to create a reliable broadcast of content, delivering the content to multiple receivers and generally includes a cine-caster, which includes a Transmission Management Module. The cine-caster module acquires the PESs from the cine-processor, as well as the scheduling information from the database, and organizes the PESs into broadcast streams. In other words, the cine-caster multiplexes content and scheduling information into transport data streams (for example), which may include one or more messages, and broadcasts it over a satellite and/or like broadcast or multicast network. Multiple programs or multi-lingual audio streams can be multiplexed in a single transport stream.

The Playback block includes a cine-blaster module for receiving the satellite (for example) transmission from the cine-caster module.

As can be seen, some embodiments of the present invention utilize a return channel from the playback module to the delivery module to facilitate error detection and recovery. For example, a satellite system may be used to broadcast (delivery module) digital content from a sender to a plurality of receivers (playback module), and preferably a wired connection (e.g., TCP/IP broadband IP, dial-up) may be used to establish a return channel for allowing the receiver to notify the sender of errors in the transmission (a wireless connection may also be used; e.g., CDMA, TDMA, etc.). While the embodiments of the present invention utilize forward-error correction techniques whenever possible, some embodiments of the invention make use of a NACK process to insure reliable broadcast.

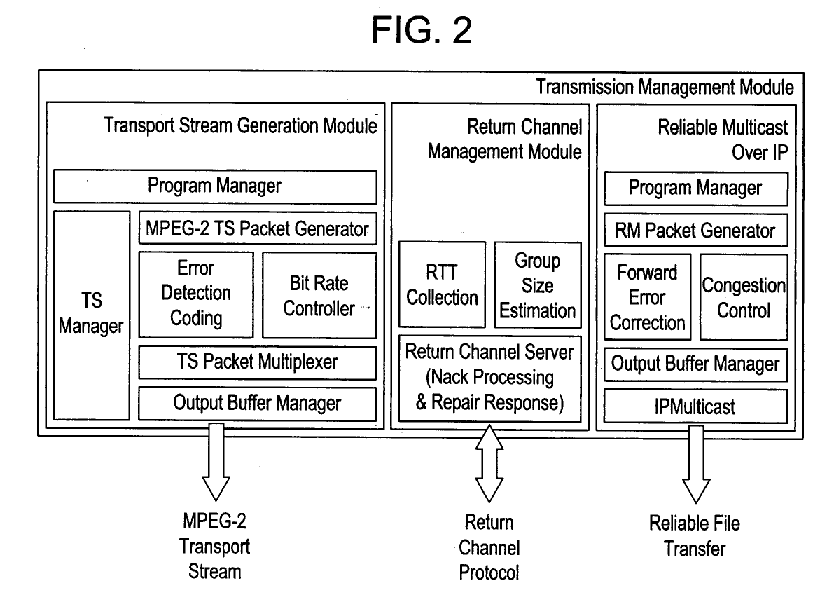

FIG. 2 illustrates components of the Transmission Management Module (TMM) of the cine-caster. As shown, the TMM may include a Transport-Stream (TS) Generation module, a Return Channel (RC) Management Module and a Reliable-Multicast (RM) over IP Module. The TS Generation Module may include a Transport-Stream Manager, a Program Manager, a MPEG-2 (or the like) Transport-Stream Generator for generating a MPEG-2 transport stream, an Error Detection Coding Module, a Bit Rate Controller, a Transport-Stream Packet Multiplexer and an Output Buffer Manager.

The Program Manager organizes audiovisual content, and Command and Control messages into MPEG2-TS Programs. It allocates program numbers and manages various Program Specific Information (PSI) tables.

The MPEG-2 TS Packet Generator generates MPEG-2 TS packets from the Audio/Video PES streams.

The Bit Rate Controller manages the bitrate for transmission by inserting null packets whenever necessary and allows Transport Stream bitrate to be changed on the fly.

The TS Packet Multiplexer multiplexes the TS packets from various media streams and PSI tables to form a single Transport Stream. It may also interface with the Bit Rate Controller to maintain a constant output bitrate.

The Error Detection Coding module is used to calculate checksum for the TS packets corresponding to every PES packet and inserts it into MPEG2-TS private tables. This checksum is used by the Receivers to verify the integrity of the received PES packets and detecting loss.

The forward error correction (FEC) Encoding [6] module allows FEC encoding use based on generating a set of parity repair packets for a set of TS packets corresponding to a PES packet.

The MPEG-2 TS private table carries information about the size of the PES packet and identifies the bounds for FEC data for a corresponding PES packet. Transmitting the FEC repair packets can reduce the amount of NACK traffic generated with relatively little overhead cost when group sizes are very large or the network connectivity has a large delay-bandwidth product with some nominal level of expected packet loss.

The Output Buffer Manager may be used to store a fixed amount of packets last transmitted in a buffer and transmits them over the DVB interface. It handles the physical transmission of the transport stream. These TS packets can be later indexed and retransmitted on the reception of NACKs over the Return Channel.

The Transport Stream (TS) Manager may be used to coordinate the working of various components from (for example) the MPEG2-TS packet generator to the Output Buffer Manager. The TS Manager interacts with the Return Channel Management Module and signals the TS Packet Multiplexer to retransmit the requested packets. It also assigns Program Ids (PIDs) to different streams in the MPEG2 TS programs.

The RC Management Module may include a return-trip timing collection module, a group-size estimation module and a Return Channel Server. The Return Channel Server is preferably used for NACK processing and repair response via the return channel protocol.

The RM Over IP module may include an RM Program Manager, an RM Packet Generator, a Forward-Error Correction module, a Congestion Control Module, an Output Buffer Manager and an IP Multicast Module.

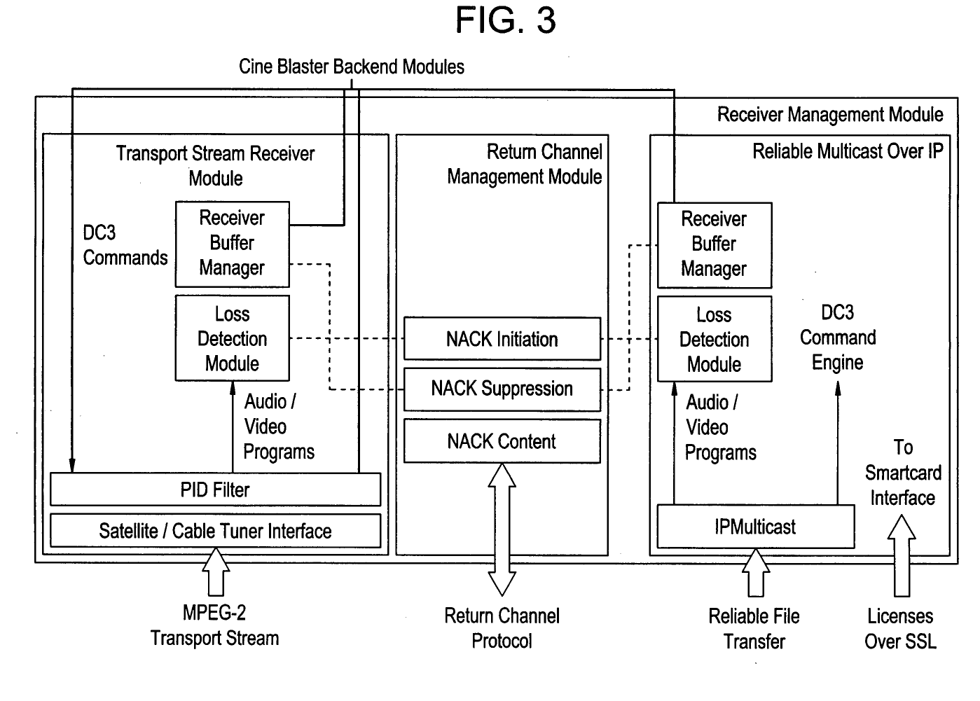

FIG. 3 illustrates components which may be included in the cine-blaster module, which may include three general components: a Transport-Stream (TS) Receiver Module for receiving the MPEG-2 Transport Stream, a Return Channel (RC) Management Module for handling the return channel protocol and a Reliable Multicast (RM) Over IP module. Accordingly, the TS Receiver Module may include a Receiver Buffer Manager, a Loss Detection Module, PID Filter, and a Satellite/Cable Tuner Interface. The RC Management Module includes NACK Initiation and NACK suppression modules, and manages the return channel protocol. The RM Over IP module includes a Receiver Buffer Manager, Loss Detection Module and IP Multicast module.

As indicated above, in addition to program content, sender messages or commands may be employed as part of the operation. Reliability of such protocol messages may be attempted by redundant transmission since ACK is prohibitive due to group size scalability concerns. For example, a command message might be redundantly transmitted by a broadcaster (sender) to indicate that it is temporarily (or permanently) halting transmission of a program. At this time, it may be appropriate for receivers to respond with NACKs for any outstanding repairs they require following the NACK rules procedure. For efficiency, the sender should allow sufficient time between redundant transmissions to receive any NACK-oriented responses from the receivers to this command.

In general, a Command and Control Engine, which may be part of the Return Channel Server (or a separate component), generates messages supporting session management and NACK suppression. The timing of redundant transmission of control messages issued by a sender is preferably dependent upon the group greatest round trip timing (GRTT) estimate. The GRTT is an estimate of the worst-case round-trip timing from a sender to any receiver in the group. It may be assumed that the GRTT interval is a conservative estimate of the maximum span (with respect to delay) of the broadcast group across a network topology with respect to given sender.

NACK Repair Process. The NACK repair process includes the detecting and requesting of repair needs by the receiver and the sender's response to such requests. Preferably, there are four elements forming the repair process: 1) Receiver NACK process initiation, 2) NACK suppression, 3) NACK message content, and 4) Sender NACK processing and response.

Receiver NACK Process Initiation. The NACK process (cycle) may be initiated by the receiver on detecting a need for repair transmissions from a specific sender to achieve reliable reception. The first TS packet for each PES packet contains the Mpeg-2 TS private table that carries information about the size of the PES packet and indicates the bounds of FEC data. If this packet is not received, the Receiver immediately signals loss and initiates the NACK process.

If the first TS packet is received, the receiver may initiate the NACK process preferably when it is known that the repair requirements exceed the amount of pending FEC transmission for a given PES packet. However, this initiation may be limited to end-of-transmission of FEC coding block or start of reception of a subsequent coding block. This may allow receivers to aggregate NACK content into a smaller number of NACK messages and provide some implicit synchronization among the receiver set in order to help in facilitating effective probabilistic suppression of NACK feedback.

Error coding may also be applied on a fully received PES packet to check message integrity. If message integrity fails, the receiver may initiate the NACK process.

The receiver preferably maintains a history of data content received from the sender to determine its current repair needs. For probabilistic, timer-base suppression of feedback, the NACK cycle begins with receivers observing backoff timeouts. In conjunction with initiating this backoff timeout, one or more receivers record the current position in the sender's transmission sequence at which they initiate the NACK cycle. When the suppression backoff timeout expires, the corresponding receivers may consider their repair needs up to this recorded transmission position (for example) in making the decision to transmit or suppress a NACK.
Receiver NACK Process Initiation Interface. Inputs: MPEG-4 PES encapsulated in MPEG-2 TS and history of content received from sender. Outputs: NACK process initiation decision and recorded sender transmission sequence position.

In one embodiment of the invention, the feedback suppression process/system is the use of random backoff timeouts before NACK transmission by receivers requiring repairs. Upon expiration of the backoff timeout, a receiver will request repairs unless its pending repair needs have been completely superseded by some indicator from the sender. The sender facilitates NACK suppression by sending an out-of-band command and control message indicating the repair information it will be sending subsequently.

For effective and scalable suppression performance, the backoff timeout periods used by receivers are preferably independently and/or randomly picked with a truncated exponential distribution. This results in the majority of the receiver group holding off transmission of NACK messages under the assumption that the smaller number of “early NACKers” will supersede the repair needs of the remainder of the group. The mean of the distribution may be determined as a function of the current estimate of sender<-> group GRTT and a group size estimate that is determined within the protocol.

A simple algorithm may be used to generate random backoff timeouts with the appropriate distribution. Additionally, such an algorithm may be designed to optimize the backoff distribution given the number of receivers (R) potentially generating feedback. This optimization may minimize the number of feedback messages (e.g., NACK) in the worst-case situation where all receivers generate a NACK. The maximum backoff timeout (T_maxBackoff) can be set to control reliable delivery latency versus volume of feedback traffic. A larger value of T_maxBackoff may result in a lower density of feedback traffic for a given repair cycle. A smaller value of T_maxBackoff results in shorter latency which also reduces the buffering requirements of senders and receivers for reliable transport.

Given a receiver group size (R), and maximum allowed backoff timeout (T_maxBackoff), random backoff timeouts (t′) with a truncated exponential distribution can be picked with the following algorithm:
1) Establish an optimal mean (L) for the exponential backoff based on the group size:
   L=ln(R)+1
2) Pick a random number (x) from a uniform distribution over a range of:

$$\frac{L}{{T\_maxBackoff}^{*} ( exp ( L ) - 1 )} to \frac{L}{{T\_maxBackoff}^{*} ( exp ( L ) - 1 )} + \frac{L}{T\_maxBackoff}$$
3) Transform this random variate to generate the desired random backoff time (t′) with the following equation:
   t′=T_maxBackoff/L*ln(x*(exp(L)−1)*(T_maxBackoff/L))

After the random backoff timeout has expired, the receiver may determine whether to generate a NACK repair request or to suppress one. The NACK may be suppressed when any (or more) of the following conditions has occurred:
1) the forwarding of accumulated state of NACKs heard from other receivers by the sender is equal to or supersedes the repair needs of the local receiver; and
2) the local receiver may have had its repair needs satisfied as a result of the sender's response to the repair needs of other receivers and no further NACK messages are required;

If these conditions have not occurred and the receiver still has pending repair needs, a NACK message may be generated and transmitted.
NACK Suppression Interface Description. Inputs: NACK process initiation decision; recorded sender transmission sequence position; sender GRTT; sender group size estimate; and application-defined bound on backoff timeout period. Outputs: Yes/no decision to generate NACK message upon backoff timer expiration.

NACK Content. The content of NACK messages generated by receivers may include information detailing a respective current repair need. Specifically, the NACK packet identifies the PES packet identifier (PES timestamp) which requires retransmission. It is worth noting that a single NACK packet may be capable of carrying any number of NACKs.
NACK Content Interface Description. Inputs: sender data identification; recorded sender transmission sequence position; current sender transmission sequence position; and history of repair needs for this sender. Outputs: NACK message with repair requests; sender repair response.

Sender Repair Response. Upon reception of a repair request from a receiver in the group, the sender will initiate a repair response procedure. Preferably, the sender delays transmission of repair content until it has had sufficient time to accumulate potentially multiple NACKs from the receiver set. This allows the sender to determine an efficient repair strategy (preferably, the most efficient repair strategy) for a given transport stream. The sender may also send a command and control message of pending repair transmissions to aid in NACK suppression. The amount of time to perform such NACK aggregation is preferably sufficient to allow for a maximum receiver NACK backoff window and propagation of NACK messages from the receivers to the sender.

Immediately after the sender NACK aggregation period, the sender may begin transmitting repair content determined from the aggregate NACK state and continue with any new transmission. Also, at this time, the sender may observe a holdoff period where it constrains itself from initiating a new NACK aggregation period to allow propagation of the new transmission sequence position due to the repair response to the receiver group. To allow for worst-case asymmetry, this holdoff time may be:
T_sndrHoldoff=1*GRTT
At the expiration of the <T_sndrAggregate> timeout, the sender may begin transmitting repair messages according to the accumulated content of NACKs received.
Sender Repair Response Interface Description. Inputs: receiver NACK messages; and group timing information. Outputs: repair messages (Data content retransmission); and advertisement of current pending repair transmissions when unicast receiver feedback is detected.

Round-trip Timing Collection. The measurement of packet propagation round-trip time (RTT) among members of the group may be required to support a timer-based NACK suppression algorithm and timing of sender commands or certain repair fuictions. Specifically, once the sender has calculated the GRTT information in a reasonably scalable manner, it preferably advertises its current GRTT estimate to the group for various timeouts used by receivers. Accordingly, one such algorithm for determining GRTT may be:
The sender periodically polls the group with a message (independent or “piggy-backed” with other transmissions) containing a <sendTime> timestamp relative to an internal clock at the sender. Upon reception of this message, the receivers will record this <sendTime> timestamp and the time (referenced to their own clocks) at which it was received <recvTime>. When the receiver provides feedback to the sender (either explicitly or as part of other feedback messages depending upon protocol instantiation specification), it constructs a response using the formula:
   grttResponse=sendTime+(currentTime−recvTime)
where the <sendTime> is the timestamp from the last probe message received from the source and the (currentTime−recvTime) is the amount of time differential since that request was received until the receiver generated the response. The sender processes each receiver response by calculating a current RTT measurement for the receiver from whom the response was received using the following formula:
   RTT_rcvr=currentTime−grttResponse
During the each periodic GRTT probing interval, the source keeps the peak round trip timing measurement (RTT_peak) from the set of responses it has received. A conservative estimate of GRTT is preferably kept to maximize the efficiency redundant NACK suppression and repair aggregation. The update to the source's ongoing estimate of GRTT may be done by observing at least one (and preferably all) of the following rules:
1) If a receiver's response round trip time (RTT_rcvr) is greater than the current GRTT estimate, the GRTT is immediately updated to this new peak value:
   GRTT=RTT_rcvr;
2) At the end of the response collection period (i.e., the GRTT probe interval), if the recorded “peak” response RTT_peak) is less than the current GRTT estimate, the GRTT is updated to:
   GRTT=MAX(0.9*GRTT, RTT_peak);
3) If no feedback is received, the sender GRTT estimate remains unchanged;

and
4) At the end of the response collection period, the peak tracking value (RTT_peak) is reset to ZERO for subsequent peak detection.

Although NORM cycle periods are based on GRTT, convergent operation of protocol mechanisms does not strictly depend on an accurate value of GRTT estimation.

Group Size Determination/Estimation. When the reliable broadcast protocol operation includes mechanisms that excite feedback from the group at large (e.g., congestion control), it may be possible to roughly estimate the group size based on the number of feedback messages received with respect to the distribution of the probabilistic suppression mechanism used. The timer-based suppression mechanism may not require a very accurate estimate of group size to perform adequately. A rough estimate, particularly if conservatively managed, may suffice.

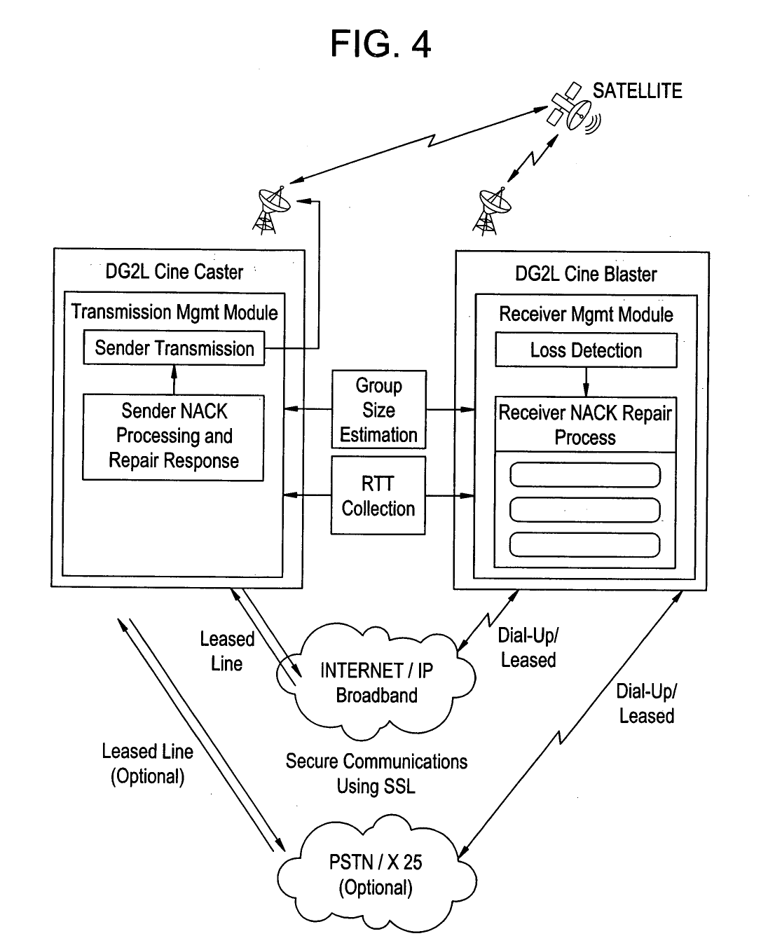

An overview of one of the above-described preferred embodiments is illustrated in FIG. 4.

The preferred embodiments described herein are provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein. Accordingly, this invention includes all modifications encompassed within the spirit and scope of the invention as defined by the claims.

References. The following references may be used as supporting subject matter for enabling one or more embodiments of the present invention. As such, the entire disclosure of each of the below listed references is herein incorporated by reference.
[1] Information Technology—Generic Coding of moving pictures and associated audio information—Systems: ISO/IEC 13818-1.
[2] Information Technology—Coding of audio-visual objects (Part 1)—Systems: ISO/IEC 14496-1
[3] Digital Video Broadcast-Satellite (DVB-S) Standard Reference: EN 300 421
[4] Digital Video Broadcast-Cable (DVB-C) Standard Reference: EN 300 429
[5] Digital Video Broadcast-Terrestrial (DVB-T) Standard Reference: EN 300 744
[6] Effective Erasure Codes for Reliable Computer Communication Protocols—Luigi Rizzo, ACM SIGCOMM Computer Communication Review, Volume 27, Issue 2 (Apr. 1997)

1. A method for error correction for digital video broadcast comprising:
receiving a digital video broadcast from a sender, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages;
initiating a repair process for sending a negative acknowledgement (NACK) to the sender for retransmitting a lost or corrupt packet.

2. The method according to claim 1, further comprising optionally receiving forward-error correction (FEC) of the TS.

3. The method according to claim 2, further comprising determining a repair requirement for initiating the repair process.

4. The method according to claim 3, wherein the repair requirement comprises a lost or corrupt PES packet.

5. The method according to claim 3, further comprising determining whether the repair requirement exceeds an amount of pending FEC transmission of a respective packet.

6. The method according to claim 5, wherein the initiation of the repair process is limited to end-of-transmission of an FEC coding block or a start of reception of a subsequent coding block.

7. The method according to claim 1, wherein a first TS packet includes a TS private table having information relating to a size of a corresponding PES packet and limits of FEC data.

8. The method according to claim 7, wherein upon the first TS packet not being received the repair process is initiated.

9. The method according to claim 1, wherein the repair process further comprises at least one of suppressing a NACK message at one or more receivers, determining content of a NACK message, processing the NACK message and receiving a response to the NACK message.

10. The method according to claim 1, further comprising receiving a back-off timeout for suppressing a NACK message.

11. The method according to claim 1, wherein the one or more messages comprises a command and/or control message from the sender.

12. The method according to claim 11, wherein the command and/or control message comprises an accumulated state of NACK messages received by the sender from substantially all other receivers.

13. The method according to claim 12, wherein a pending NACK message is suppressed upon the pending NACK message being superceded by the command and/or control message.

14. A computer readable medium having computer instructions provided thereon for enabling a computer to perform a method for error correction for digital video broadcast, the method comprising:
receiving a digital video broadcast from a sender, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages;
initiating a repair process for sending a negative acknowledgement (NACK) to the sender for retransmitting a lost or corrupt packet.

15. A computer application program for enabling a computer to perform a method for error correction for digital video broadcast, the method comprising:
receiving a digital video broadcast from a sender, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages;
initiating a repair process for sending a negative acknowledgement (NACK) to the sender for retransmitting a lost or corrupt packet.

16. An apparatus for error correction for digital video broadcast comprising:
receiving means for receiving a digital video broadcast from a sender, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages; and
initiating means for initiating a repair process for sending a negative acknowledgement (NACK) to the sender for retransmitting a lost or corrupt packet.

17. A receiver for a digital DVB system comprising a playback module for receiving the transport stream and for initiating a repair process for sending a negative acknowledgement (NACK) to the sender for retransmitting a lost or corrupt packet, the playback module including a return management module for initiating a negative acknowledgement (NACK) message and determining a content of the message, a transport stream receiver module, and a reliable multicast over IP module.

18. A method for negative acknowledgement (NACK) suppression on a digital video broadcast (DVB) network comprising:
transmitting a digital video broadcast to a plurality of receivers, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages;
estimating a sender-group greatest-round-trip-timing (GRTT) for a group of receivers in the DVB network;
estimating a size of the group;
randomly selecting a respective back-off timeout period for the group according to a truncated exponential distribution; and
determining a mean of the distribution as a function of the sender-group estimate and the size estimate of the group.

19. A computer readable medium having computer instructions provided thereon for enabling a computer system to perform a method for negative acknowledgement (NACK) suppression on a digital video broadcast (DVB) network, the method comprising:
transmitting a digital video broadcast to a plurality of receivers, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages;
estimating a sender-group greatest-round-trip-timing (GRTT) for a group of receivers in the DVB network;
estimating a size of the group;
randomly selecting a respective back-off timeout period for the group according to a truncated exponential distribution; and
determining a mean of the distribution as a function of the sender-group estimate and the size estimate of the group.

20. A computer application program for enabling a computer system to perform a method for negative acknowledgement (NACK) suppression on a digital video broadcast (DVB) network, the method comprising:
transmitting a digital video broadcast to a plurality of receivers, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages;
estimating a sender-group greatest-round-trip-timing (GRTT) for a group of receivers in the DVB network;
estimating a size of the group;
randomly selecting a respective back-off timeout period for the group according to a truncated exponential distribution; and
determining a mean of the distribution as a function of the sender-group estimate and the size estimate of the group.

21. An apparatus for negative acknowledgement (NACK) suppression on a digital video broadcast (DVB) network comprising:
transmitting means for transmitting a digital video broadcast to a plurality of receivers, the digital video broadcast comprising:
a multiplexed packetized transmission stream (TS) comprising at least one packetized elementary stream (PES) for predetermined content and comprising at least one of related meta-data information, integrity check information, frame information, related frame meta-data, frame integrity check information and one or more messages;
estimating means for estimating a sender-group greatest-round-trip-timing (GRTT) for a group of receivers in the DVB network, and/or for estimating a size of the group;
random selection means for randomly selecting a respective back-off timeout period for the group according to a truncated exponential distribution; and
determining means for determining a mean of the distribution as a function of the sender-group estimate and the size estimate of the group.

22. A transmission device for a digital DVB system comprising:
a creation module for capturing and encoding digital content;
a processing and management module for processing the captured content; and
a delivery module for creating a transport stream of data packets for the content to a plurality of receivers, the delivery module comprising a transmission management module including a transport stream generation module, a return channel management module and a reliable multicast module, wherein the return channel management module includes a negative acknowledgement (NACK) processing module a receiver group greatest-round-trip estimation module and a group size estimation module.
